(19) United States
(12) Patent Application Publication
(10) Pub. No.: US 2002/0132087 A1
(43) Pub. Date: Sep. 19, 2002

(54) Female engaging surface fastener having a backing and method of making same

(76) Inventors: Wolfgang Coronel, Macon, GA (US); Nobuo Fujisawa, Macon, GA (US); Craig Jay Graham, Eastman, GA (US); Tsuyoshi Minato, Macon, GA (US); David D. Smith, Dublin, GA (US)

Correspondence Address: Terry W. Kramer, Esq., Kramer & Associates, Suite 1101, 2001 Jeff. Davis Hwy., Arlington, VA, 22202, US

(21) Appl. No.: 09/961,357

(22) Filed: Sep. 25, 2001

Related U.S. Application Data
(60) Provisional application No. 60/275,485, filed on Mar. 14, 2001.

(51) Int. Cl. B32B 3/02; A46D 1/00; D04H 11/00; B32B 29/02; B32B 33/00; B32B 5/00

(52) U.S. Cl. 428/99; 428/85; 428/95; 428/96; 428/92; 156/72; 156/166; 156/176; 156/178

(57) ABSTRACT

A method for producing an extruded sheet material wherein a polymeric material is formed into a sheet and a variety of materials are incorporated into the extruded material prior to hardening. The sheet materials produced incorporate, either sheet, filament or particulate matter onto either side of the finished product, allowing for great variability in the finished product.

### BACKGROUND OF THE INVENTION

This application claims the benefit of U.S. Provisional Application No. 60/275,485 entitled “Female Engaging Surface Fastener Having A Backing And Method For Making Same,” filed on Mar. 14, 2001.

The present invention relates to the field of surface fasteners and their production. In particular, the present invention relates to surface fasteners that are manufactured from polymeric resins, have female engaging members bonded thereto and, additionally, include a second element bonded to the surface fastener.

Surface engaging fasteners are well know in the art and are commonly found to be of a hook and loop configuration. These are largely found to be manufactured according to two wellknown processes. The more traditional method provides for the weaving of both the hook element and the loop element. The loop element is usually woven from a multifilament yarn, creating a patterned web with raised protrusions forming the loop elements. These loops may then be napped, in a separate procedure to separate the multifilaments and increase the number of loops, which may be held by the hook. The hook is commonly also woven through a similar weaving procedure, but due to peel and shear demands, must be constructed with a higher denier fiber. The hook fiber is commonly constructed from a monofilament, and after weaving, results in a similar patterned web with raised protrusions. After weaving of the hook element, the raised, woven protrusions are incapable of binding to the loop element as a result of the weaving procedure. In order for the woven monofilament to actually function as a hook, it must undergo a slitting procedure where each raised protrusion is cut, thereby allowing the monofilament hook to engage at least one or more of the napped multifilaments of the loop element. The hook tips may also be melted to produce a mushroom shape that engages another mushroom hook element. Such a conventional device and method is illustrated in U.S. Pat. No. 3,009,235, entitled “Separable Fastening Device.”

A second method of producing hook and loop surface fasteners involves extruding a plate-like sheet element and imparting the desired hook profile unto the extruded material. This method allows for the production of a hook element, similar to the above woven hook but at reduced manufacturing costs. A further improvement in the manufacture of hook and loop elements is illustrated in U.S. Pat. No. 5,974,635, entitled “Female Engaging Member of Surface Fastener and Method of Manufacturing the Same.” In this process, a series of multifilament yarns are arranged in parallel relationship to each other and at regular intervals. The parallel yarns are then converged with a flat plate-like sheet member being fed from a roll at a constant rate. The finished product allows for the production of a loop element through a partial extrusion process through the incorporation of a multifilament or monofilament yarn product to the flat plate-like sheet member.

Another method of producing an extruded hook product is disclosed in U.S. Pat. No. 5,744,080, entitled “Laminated Hook Fastener.” The laminated product is manufactured through the extrusion of plastic material onto a roll having hook forming cavities on its surface. A second plastic material is further extruded at an interface between a forming roll and a second strip carried by a backing roll to form a finished article having extruded loop material on one surface and a sheet material on its second surface. This product requires the use of a plastic bonding material to join the extruded hook layer to the added sheet layer.

Although the prior art has shown the woven and extruded manufacture of hook and loop elements along with the plastic bonding of sheet backing materials to extruded hook elements, there is still a need for the manufacture of an extruded loop fastening element having backing surfaces that may include a variety of materials, either in sheet or particulate form.

### SUMMARY OF THE INVENTION

In accordance with these and other objects of the invention, a brief summary of the present invention is presented. Some simplifications and omission maybe made in the following summary, which is intended to highlight and introduce some aspects of the present invention, but not to limit its scope. Detailed descriptions of a preferred exemplary embodiment adequate to allow those of ordinary skill in the art to make and use the invention concepts will follow in later sections.

It is therefore a primary object of the present invention to provide a non-woven product having fastening loop elements on one surface along with a second material on a second surface.

It is a further object of the present invention to provide for a method of efficiently producing such a product through a manufacturing process that allows for the production of a dual sided, nonwoven article including fastening loop elements on one surface along with a second material on a second surface.

It is still another object of the present invention to accomplish the above-stated objects by utilizing a method and apparatus, which is simple in design and use, and efficient to manufacture.

According to a broad aspect of the present invention, a surface fastening device is disclosed which includes a sheet like structure having a first surface with a material selected from yarn, thread, sheet material and particulate material bonded thereto and a second surface with a material selected from yarn, thread, sheet material and particulate material also bonded thereto.

According to another broad aspect of the present invention, a method is disclosed for producing a surface fastening device. The method includes the extrusion of a sheet like structure having the ability to bind a material prior to hardening. A material selected from yarn, thread, sheet to material, particulate material and combinations thereof is brought into contact with one face of the extruded sheet prior to its hardening. A second material selected from yarn, thread, sheet material, particulate material and combinations thereof is also brought into contact with a second face of the extruded sheet prior to hardening and the sheet is allowed to harden.

The foregoing objects and advantages of the invention are illustrative of those that can be achieved by the present invention and are not intended to be exhaustive or limiting of the possible advantages which can be realized. Thus, these and other objects and advantages of the invention will be apparent from the description herein or can be learned from practicing the invention, both as embodied herein, or as modified in view of any variation which may be apparent to those skilled in the art. Accordingly, the present invention resides in the novel methods, arrangements, combinations and improvements herein shown and described.

### BRIEF DESCRIPTION OF THE DRAWINGS

FIG. 1 is a cross sectional view schematically showing one embodiment of a production apparatus of the present invention.

FIG. 2 is a cross sectional view schematically showing one embodiment of a production apparatus of the present invention.

FIG. 3 is a cross sectional view schematically showing one embodiment of a production apparatus of the present invention.

FIG. 4 is a cross sectional view schematically showing one embodiment of a production apparatus of the present invention.

FIG. 5 is a perspective view of the surface fastening product having an attached backing.

FIG. 6 is a perspective view of an additional embodiment of the surface fastening product having an attached backing.

### DETAILED DESCRIPTION OF THE PREFERRED EMBODIMENTS

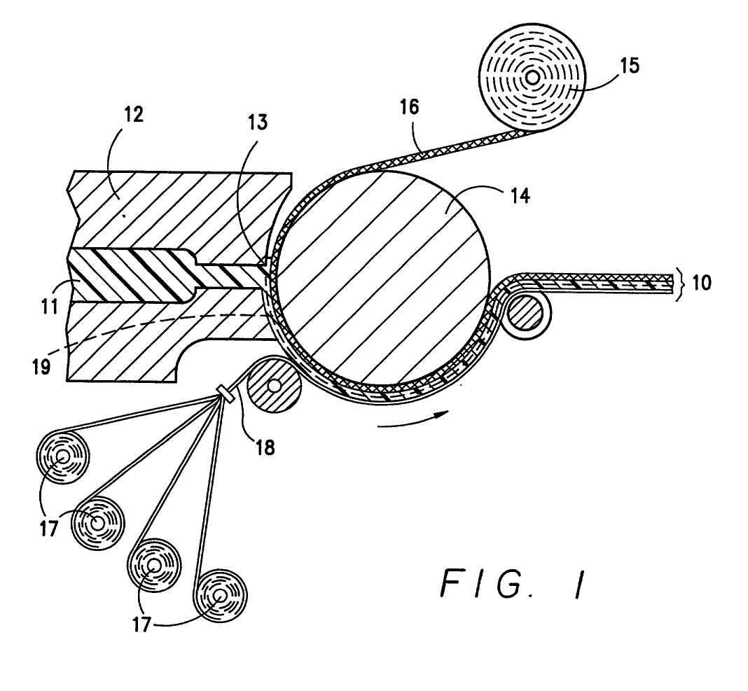

Referring now to the drawings, in which like numerals refer to like components or steps, there is disclosed in FIG. 1 broad aspects of a preferred embodiment of the present invention. FIG. 1 discloses a general arrangement of an apparatus for use in the production of one embodiment of the present invention system. A polymeric material 11, such as polyvinyl chloride (PVC), or polypropylene, is found in its molten state inside a holding vessel 12. A spinning roll 14 is found in close proximity to a discharge nozzle 13. A first material dispenser 15, housing a sheet material 16 is located proximal to the spinning roll 14. Multiple material dispensers 17, each housing a respective filament material 18 are also located in proximity to the spinning roll 14. In use, the sheet material 16 and the filament material 18 are fed into the spinning roll 14. As the molten material 19 is extruded through the discharge nozzle 13, it assumes the shape given to it by the spinning roll 14 but does not immediately harden. During this hardening period, the material 11 remains tacky. As the molten material 19 is discharged, it is brought into contact with the sheet material 16 on one face and filament material 18 on its opposite face. The molten material 19, having the sheet material 16 and the filament material 18 bonded to either face, is then discharged at a point in the spinning roll 14, opposite the discharge nozzle 13. The finished product 10 includes a sheet like structure including a sheet like material such as paper, abrasive paper, non-woven fabric, woven and knitted textiles, scrims, netting, plastic film, extruded male fastening members, molded male fastening members and metallic screening on one face, an intermediate polymeric material such as PVC, and a filament material, such as yarn or thread on the opposite face of the polymeric material.

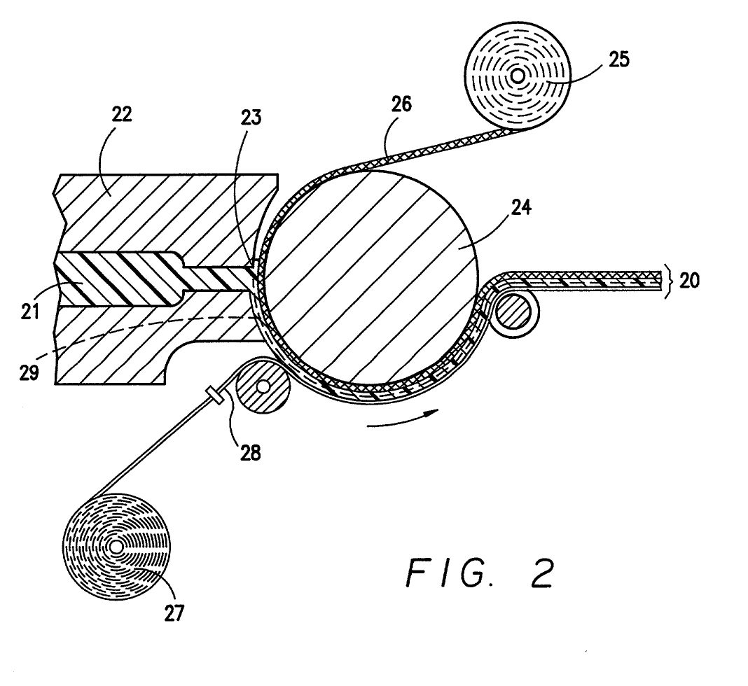

FIG. 2 shows a general arrangement of an apparatus for use in the production of another embodiment of the present invention. Again, a polymeric material 21, is found in a molten state inside a holding vessel 22. A spinning roll 24 is found in close proximity to a discharge nozzle 23. A first material dispenser 25 housing an abrasive sheet material 26, such as sandpaper, is located in proximity to the spinning roll 24. A second material dispenser 27, housing a second sheet material, such as a web of extruded or molded hook surface fasteners 28 is also located in proximity to the spinning roll 24. In use, the abrasive sheet material 26 and the second sheet material 28 are fed into the spinning roll 24. As the molten material 29 is extruded through the discharge nozzle 23, the molten material 29 assumes the shape given to it by the spinning roll 24 but does not immediately harden. During this hardening period, the material 11 remains tacky. As the molten material 29 is discharged, it is brought into contact with the abrasive sheet material 26 on one face and second sheet material 28 on its opposite face. The molten material 29 having the abrasive sheet material 26 and the second sheet material 28 bonded to either face is then discharged at a point in the spinning roll 24, opposite the discharge nozzle 23. The finished product 20 is a sheet like structure including a sheet like material such as paper, abrasive paper, non-woven fabric, woven and knitted textiles, scrims, netting, plastic film, extruded male fastening members, molded male fastening members and metallic screening on one face, an intermediate polymeric material such as PVC, and a second sheet like material, such as paper, abrasive paper, non-woven fabric, woven and knitted textiles, scrims, netting, plastic film, extruded male fastening members, molded male fastening members and metallic screening on the opposite face of the polymeric material.

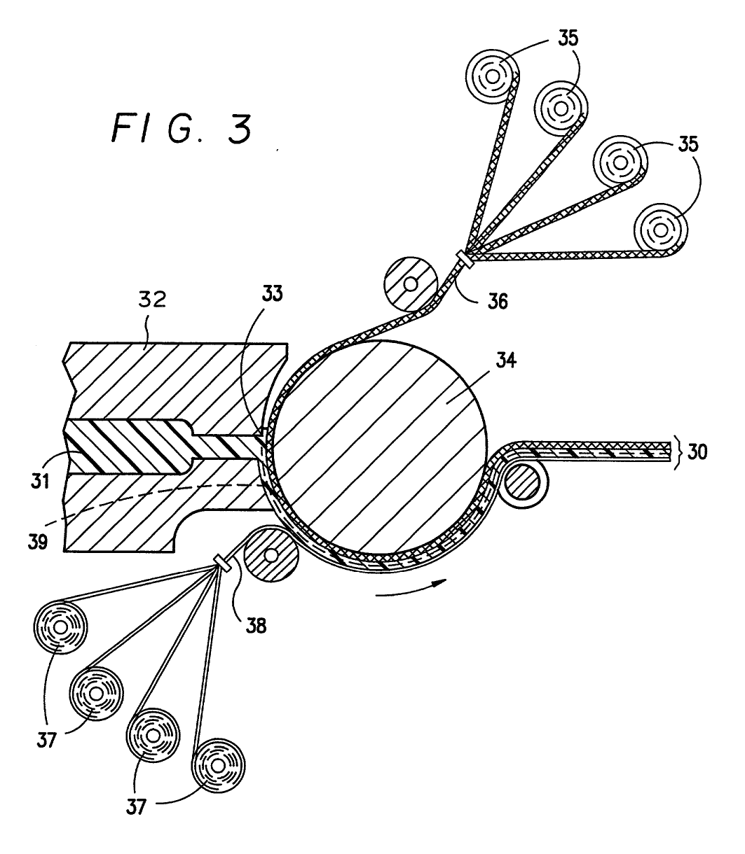

FIG. 3 shows a general arrangement of an apparatus for use in the production of a further embodiment of the present invention. Again, a polymeric material 31, is found in a molten state inside a holding vessel 32. A spinning roll 34 is found in close proximity to a discharge nozzle 33. Multiple filament dispensers 35 housing a filament material 36, such as yarn, are located in proximity to the spinning roll 34. A second set of multiple filament dispensers 37, housing a filament material 38, such as yarn, are also located in proximity to the spinning roll 34. In use, the first set of filament material 36 and the second set of filament material 38 are fed into the spinning roll 34. As the molten material 39 is extruded through the discharge nozzle 33, it assumes the shape given to it by the spinning roll 34 but does not immediately harden. During this hardening period, the material 31 remains tacky. As the molten material 39 is discharged, it is brought into contact with the first set of filament material 36 on one face and the second set of filament material 38 on its opposite face. The molten material 39 having the first set of filament material 36 and the second set of filament material 38 bonded to either face is then discharged at a point in the spinning roll 34, opposite the discharge nozzle 33. The finished product 30 forms a sheet like structure including a set of filament material such as yarn or thread on one face, an intermediate polymeric material such as PVC, and a second set of filament material, such as yarn or thread on the opposite face of the polymeric material.

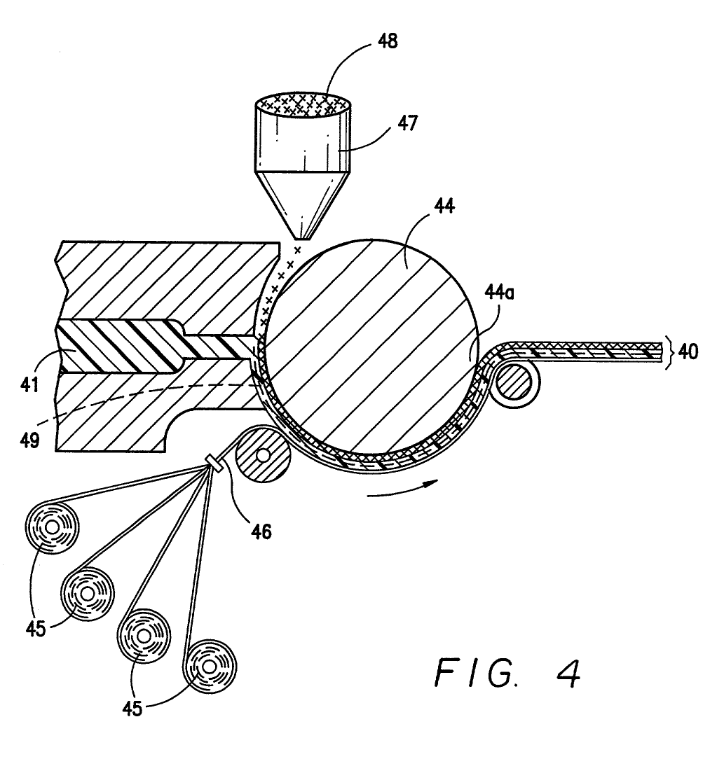

FIG. 4 shows a general arrangement of an apparatus for use in the production of yet a further embodiment of the present invention. Again, a polymeric material 41, is found in a molten state inside a holding vessel 42. A spinning roll 44 is found in close proximity to a discharge nozzle 43. Multiple filament dispensers 45 housing a filament material 46, such as yarn, are located in proximity to the spinning roll 44. A particulate matter dispenser 47, housing a particulate material 48, such as abrasive particles, is also located in proximity to the spinning roll 44. In use, the filament material 46 and the particulate material 48 are fed into the spinning roll 44. As the molten material 49 is extruded through the discharge nozzle 43, it assumes the shape given to it by the spinning roll 44 but does not immediately harden. During this hardening period, the material 49 remains tacky. As the molten material 49 is discharged, it is brought into contact with the filament material 46 on one face and the particulate material 48 on its opposite face. The molten material 49 having a filament material 46 and particulate material 48 bonded to either face is then discharged at a point in the spinning roll 44a, opposite the discharge nozzle 43. The finished product 40 includes a sheet like structure including a set of filament material such as yarn or thread on one face, an intermediate polymeric material such as PVC, and an abrasive particulate material, such as diamond particles on the opposite face of the polymeric material.

The finished articles 10 and 40, described with reference to FIGS. 1 and 4 above, may be used for creating a sheet like article having an abrasive surface and an opposite female engaging surface. Such an article may be utilized in the construction industry in applications such as circular or vibration driven sanders. For example, a disk sander may be fitted with hook elements on the face of the disk. The female engaging face of the finished articles 10 and 40 having bound filament material may then be engaged with the hook material of the disk sander. The material may then be utilized until the abrasive qualities of the articles 10 and 40 are diminished. The article may then be easily removed and a replacement article 10 or 40 engaged. An article 20, as described with reference to FIG. 2, may also be used for a similar application when the first sheet material 26 includes an abrasive containing sheet material and the second sheet material 27 includes a sheet material such as a web of extruded or molded hook surface fasteners. Such a product would function in a similar way to the articles 10 and 40 described with reference to FIGS. 1 and 4 but the disk sander would included a loop element that engages second sheet material 27 having hook surface fasteners. The finished article 30 described in FIG. 3 may be used in applications where a double-sided loop structure is desired.

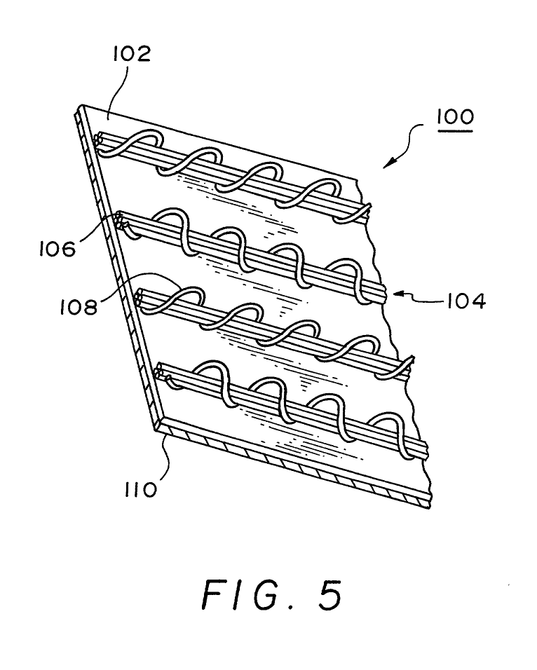

Turning now to FIG. 5, an embodiment of the finished product is shown. The product 100 includes a sheet-like substrate 102. Pile-shaped engaging elements 104 are bonded to one side of the substrate 102. Pile-shaped engaging elements 104 are made from a plurality of filaments 108 which are wound around core threads 106. The winding filament 108 has a longer length than the circumference of the core thread 106 or threads thus allowing loops of filaments 108 to extend from the core threads 106. The process of forming the pile-shaped engaging elements 104 is known in the art and is shown in U.S. Pat. No. 5,974,635, which is herein incorporated by reference. Therefore no further discussion of the process is necessary.

The sheet-like substrate 102 also includes a backing material 110. The number of possible backing materials 110 is unlimited. Sand paper, abrasive grit, adhesive paper products, paper products, paper products including indicia or advertising, woven textile products, non-woven textile products, etc. can all be used as the backing material 110.

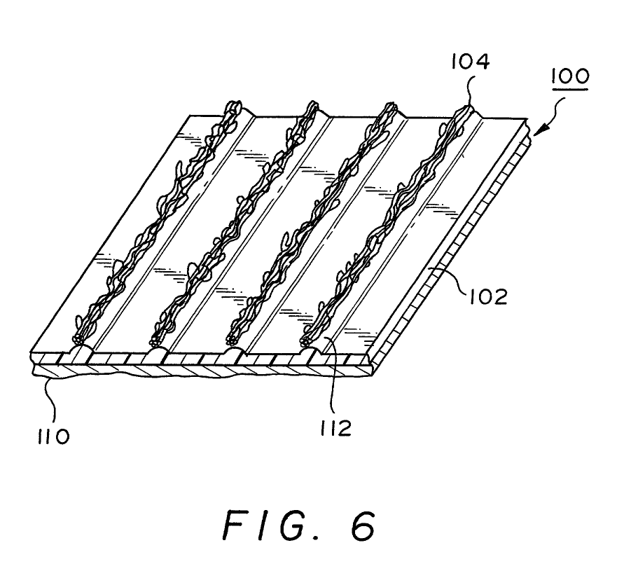

FIG. 6 discloses an additional embodiment of the present invention. The product 100 includes a sheet-like substrate 102. The substrate 102 includes rows of elevated portions 112. Each pile-shaped engaging element 104 meets and is bonded to an upper part of the elevated portions 112. This provides additional strength to the bond between the pile-shaped engaging element 104 and the substrate 102. Again the sheet-like substrate 102 also includes a backing material 110. The number of possible backing materials 110 is unlimited. Sand paper, abrasive grit, adhesive paper products, paper products, paper products including indicia or advertising, woven textile products, non-woven textile products, etc. can all be used as the backing material 110.

Although the present invention has been described in detail with particular reference to preferred embodiments thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and FIGS. are for illustrative purposes only, and do not in any way limit the invention, which is defined only by the claims.

What is claimed is:

1. A product having a surface fastener, comprising:
a sheet-like substrate having a first surface and a second surface;
a plurality of rows of pile-shaped engaging elements bonded to the first surface of the sheet-like substrate and having a plurality of filaments wound around a core thread such that the winding of each filament wound around the core thread has a length greater than that of the outer periphery of the core thread; and
a material bonded to the second surface of the substrate.

2. The product of claim 1, wherein the material is sand paper.

3. The product of claim 1, wherein the material is abrasive grit.

4. The product of claim 1, wherein the material is a sheet of male engaging members complementary to the pile-shaped engaging elements.

5. The product of claim 1, wherein the material is a woven textile product.

6. The product of claim 1, wherein the material is non-woven textile product.

7. The product of claim 1, wherein the material is a sheet having an adhesive portion.

8. The product of claim 1, wherein the material is a sheet of a paper product.

9. The product of claim 1, wherein the first surface of the sheet-like substrate includes a plurality of rows of elevated portions and wherein each pile-shaped engaging element is bonded with top faces of the elevated portions.

10. The product of claim 9, wherein the material is sand paper.

11. The product of claim 9, wherein the material is a sheet of male engaging members complementary to the pile-shaped engaging elements.

12. The product of claim 9, wherein the material is a woven textile product.

13. The product of claim 9, wherein the material is non-woven textile product.

14. The product of claim 9, wherein the material is a sheet having an adhesive portion.

15. The product of claim 9, wherein the material is a sheet of a paper product.

16. A method of making product, comprising:
continuously extruding a polymeric material onto a spinning roller such that the polymeric material is formed into a sheet having a first surface and a second surface;
providing a plurality of pile-shaped engaging elements having a plurality of filaments wound around a core thread such that the winding of each filament wound around the core thread has a length greater than that of the outer periphery of the core thread;
feeding the pile-shaped engaging elements into engagement along the first surface of the polymeric material;
providing a sheet of material; and
feeding the sheet of material into engagement along the second surface of the polymeric material.

17. The method of claim 16, wherein the sheet of material is sand paper.

18. The method of claim 16, wherein the sheet of material is a sheet of male engaging members complementary to the pile-shaped engaging elements.

19. The method of claim 16, wherein the sheet of material is a woven textile product.

20. The method of claim 16, wherein the sheet of material is a non-woven textile product.

21. The method of claim 16, wherein the polymeric material is extruded such that the first surface includes rows of elevated portions and wherein each piled-shaped engaging elements is fed along the elevated portion.

22. The method of claim 16, wherein the sheet of material is sand paper.

23. A method of making product, comprising:
continuously extruding a polymeric material onto a spinning roller such that the polymeric material is formed into a sheet having a first surface and a second surface;
providing a plurality of pile-shaped engaging elements having a plurality of filaments wound around a core thread such that the winding of each filament wound around the core thread has a length greater than that of the outer periphery of the core thread;
feeding the pile-shaped engaging elements into engagement along the first surface of the polymeric material;
providing a supply of abrasive grit; and
feeding the abrasive grit into engagement along the second surface of the polymeric material.

24. The method of claim 23, wherein the polymeric material is extruded such that the first surface includes rows of elevated portions and wherein each piled-shaped engaging elements is fed along the elevated portion.
